(19) United States
(12) Patent Application Publication
(10) Pub. No.: US 2022/0024726 A1
(43) Pub. Date: Jan. 27, 2022

(54) ELEVATOR DOOR ARRANGEMENT WITH DOOR PANEL ADJUSTABILITY IN AT LEAST TWO DIMENSIONS

(71) Applicant: Inventio AG, Hergiswil (CH)

(72) Inventors: EDUARDO DE CASTRO BATISTA, Sao Paulo (BR); JOSE ROBERTO CAZETTA, Sao Berbardo Do Campo (BR)

(21) Appl. No.: 17/309,588

(22) PCT Filed: Dec. 11, 2019
(86) PCT No.: PCT/EP2019/084585

§ 371 Date: Jun. 8, 2021

(51) Int. Cl. B66B 13/30; E05D 15/06

(52) U.S. Cl. CPC B66B 13/30; E05D 15/0626; E05Y 2600/20; E05Y 2900/104; E05Y 2201/622

(57) ABSTRACT

Elevator door arrangement includes door panel connected to door mechanism by an interface member. Door panel first fixation plate section and door mechanism second fixation plate section extend in horizontal and vertical planes respectively. Interface member has first and second interconnection plate sections extending parallel to the horizontal and vertical planes respectively. Third oblong through-hole extends in second horizontal direction in first fixation plate section, first oblong through-hole extends in first horizontal direction in first interconnection plate section transverse to the second horizontal direction, and second oblong through-hole extends in vertical direction in second fixation plate section. Door panel is fixed to interface member by a first fixation member vertically extending through the first and optionally the third through-holes and interface member is fixed to door mechanism by a second fixation member horizontally extending through the second through-hole establishing 2-dimensional or 3-dimensional door panel adjustability.

### FIELD

The present invention relates to an elevator door arrangement in which a location of a door panel may be adjusted.

### BACKGROUND

An elevator typically comprises an elevator car which may be displaced between various floors or levels for transporting passengers within a building. Typically, a passenger may enter into and exit from the elevator car through an elevator door. The elevator door may be opened as long as the elevator car is waiting at a floor and may be closed when the elevator car is displaced.

Generally, an elevator door arrangement comprises a door mechanism as well as one or more door panels. The door mechanism is configured for moving the one or more door panels in a horizontal direction from an open position, in which the door panel(s) shall leave a door opening open, to a closed position, in which the door panel(s) block the door opening. The one or more door panels are configured in their size and positioning such as to fully block the door opening in order to stop passengers from passing through the door opening when the elevator door arrangement is closed.

There are various types of elevator door arrangements. For example, in a centrally opening door arrangement, two or more door panels may be moved in opposite directions in order to open and close, respectively, a central door opening. In a lateral opening door arrangement, one or more door panels may be moved in a common direction in order to open and close, respectively, a lateral door opening. Generally, door arrangements may be provided both, in the elevator car and at a floor level at an entrance to an elevator shaft.

Generally, the door mechanism and the one or more door panels are provided with separate structural elements. Upon installing the elevator door arrangement, the one or more door panels have to be mounted to the door mechanism. In such mounting procedure, a position of the one or more door panels with respect to the door mechanism is to be adjusted. For example, such adjustment should be such that the door panels may be freely displaced along a motion path upon the door mechanism being actuated.

For example, the position of the door panels should be adjusted such that the door panels completely close the door opening upon the door mechanism being displaced towards a closing position and the door panels open the door opening to a maximum upon the door mechanism being displaced towards an opening position. Upon adjusting the position of the one or more door panels, gaps between the door panels and adjacent structures such as adjacent parts of the elevator door arrangement should be dimensioned such that for example a smooth, frictionless motion of the door panels is enabled. On the other hand, the gaps should be dimensioned such that, for example, these gaps do not obtain dangerous dimensions and/or excessive tolerances in the door panel motions caused by these gaps are avoided.

EP 0 456 525 B1 discloses an adjustable fixation device for door panels in an elevator car.

### SUMMARY

There may be a need for an elevator door arrangement in which the position of one or more door panels may be precisely adjusted such as to fulfil at least some of the above-mentioned requirements. Furthermore, there may be a need for an elevator arrangement in which the position of one or more door panels with respect to a door mechanism may be adjusted in appropriate spatial directions. Particularly, there may be a need for an elevator arrangement in which the position of one or more door panels may be easily adjusted for example by a single technician.

Such needs may be met with the subject-matter of the advantageous embodiments defined in the following specification.

According to an aspect of the present invention, an elevator door arrangement with at least 2-dimensional door panel adjustability is proposed. The elevator door arrangement comprises at least one door panel, an interface member and a door mechanism. The door mechanism is supported by a door frame fixedly installed within the elevator door arrangement and is displaceable relative to the door frame. The door panel is fixedly connected to the door mechanism via the interface member. In such configuration, the door panel comprises a first so-called fixation plate section extending in a horizontal plane, the door mechanism comprises a second fixation plate section extending in a vertical plane and the interface member comprises a first so-called interconnection plate section and a second interconnection plate section, the first interconnection plate section extending parallel to the horizontal plane and the second interconnection plate section extending parallel to the vertical plane. The first interconnection plate section comprises a first oblong through-hole extending in a first horizontal direction. As used herein, the term “oblong” refers to the shape of the through-holes in cross section being elongated (extending) in the specified direction. The second fixation plate section comprises a second oblong through-hole extending in the vertical direction. The door panel is fixed to the interface member via a first fixation member vertically extending through the first oblong through-hole. The interface member is fixed to the door mechanism via a second fixation member horizontally extending through the second oblong through-hole.

Ideas underlying embodiments of the present invention may be interpreted as being based, inter alia and without restricting the scope of the invention, on the following observations and recognitions.

In conventional elevator door arrangements, a position of a door panel may generally only be adjusted to a limited extent. Specifically, in most prior art approaches, the position of the door panel may be varied in at most two dimensions, wherein adjusting the position of the door panel in one direction generally interferes with adjusting the position of the door panel in the second direction. For example, the door panel may be fixed to the door mechanism via screws, these screws extending through oblong holes such that, upon the screws being released, the door panel may be displaced along a single vertical plane, i.e. in a vertical direction and/or in a horizontal direction parallel to a motion direction of the door panel. However, such displacing capability is generally implemented such that when the door panel is displaced in the vertical direction there is a risk that the door panel is unintendedly also displaced in the horizontal direction, and vice versa. Furthermore, in conventional approaches, an option for adjusting the position of the door panel in another horizontal direction perpendicular to the motion direction of the door panel is generally not implemented.

In other words, conventionally, provisions are made such as to allow adjusting the position of the door panel in the vertical direction, i.e. adjust the height level of the door panel and thereby adjusts a vertical gap for example between the door panel and a header of the door arrangement, and/or to allow adjusting the position of the door panel in one horizontal direction, i.e. adjust the lateral position of the door panel in a width direction of the door arrangement and thereby adjust a horizontal lateral gap for example between the door panel and a column of the door arrangement.

However, conventionally, both adjusting capabilities correlate, i.e. are interdependent. Furthermore, conventionally, no provisions are made for enabling a displacement of the door panel in the other horizontal direction in order to thereby for example adjust a horizontal gap for example between the door panel and a sill of the door arrangement.

In contrast hereto, the elevator door arrangement proposed herein enables a 2-dimensional door panel adjustability in which adjusting the position in a horizontal direction may be done independent of adjusting the position in the vertical direction. Furthermore, in advanced embodiments of the invention, even 3-dimensional door panel adjustability may be established, i.e. the one or more door panels may be repositioned in all three spatial directions and gaps between the door panels and adjacent structures or components may be adjusted in all of three orthogonal directions.

In order to establish such 2-dimensional or even 3-dimensional door panel adjustability, the proposed elevator door arrangement does not only comprise one or more door panels and a door mechanism but additionally comprises a further component referred to herein as an interface member. Such interface member may be seen as an interface between the door panel and the door mechanism such that the door panel may be mechanically connected to the door mechanism via the intermediate interface member. The door mechanism itself is supported or held by a door frame, this door frame being fixedly installed in the elevator door arrangement.

Therein, the structural and functional characteristics of the door panel, the interface member and the door mechanism are implemented such that the door panel may be easily and precisely displaced relative to the door mechanism in at least two dimension or preferably in all three dimensions.

In order to fulfil such objectives, the door panel comprises a first so-called fixation plate section, the door mechanism comprises a second fixation plate section and the interface member comprises a first and a second so-called interconnection plate sections.

This first fixation plate section is a section of the door panel that generally is substantially planar or flat and extends in a horizontal plane. The first fixation plate section may be integral to a remainder of the door panel. For example, the door panel may be made from a sheet material. A major part of this sheet material extends in a vertical plane including the width direction of the door panel. However, for example at an upper end, the sheet material may be bent such as to form the horizontal first fixation plate section. Typically, the horizontal first fixation plate section extends along a major portion of the width or the entire width of the door panel and has a depth in a horizontal direction perpendicular to the width direction of a few centimeters, for example of between 1 and 10 cm.

The second fixation plate section generally is also substantially planar or flat and extends in a vertical plane. The second fixation plate section may be integral to a remainder of the door mechanism. For example, the door mechanism may be made from a sheet material, a majority of this sheet material extending in a vertical plane including the width direction, i.e. in a plane being parallel to the plane of the door panel. In this sheet material, the vertical second fixation plate section may be included.

With the first and second fixation plate sections being arranged in planes rectangular to each other, the interface member may have a structure and geometry such as to create an interface between both planes, thereby enabling fixing the door panel to the door mechanism via the intermediate interface member.

For such purpose, the interface member comprises the first and second interconnection plate sections. The structure and geometry of the interface member is such that these interconnection plate sections are arranged perpendicular to each other. For example, a cross-section of the interface member may have an L-shaped profile with one leg of the “L” forming the first interconnection plate section and the other leg of the “L” forming the second interconnection plate section. The first interconnection plate section extends parallel to the horizontal plane and therefore parallel to the first fixation plate section at the door panel. The second interconnection plate section extends parallel to the vertical plane and therefore parallel to the second fixation plate section at the door mechanism.

With such structural characteristics, the interface member may be arranged for example such as to abut with a surface at its first interconnection plate section to a surface of the first fixation plate section at the door panel and to abut with a surface of its second interconnection plate section to a surface of the second fixation plate section at the door mechanism.

The first interconnection plate section in the interface member comprises a first oblong through-hole. This first oblong through-hole extends in a first horizontal direction being transverse, preferably being rectangular, to a second horizontal direction in which a third oblong through-hole may extend (see further below). In other words, the first oblong through-hole and the optional third oblong through-hole extending in the interface member and in the door panel, respectively, may be arranged in transverse, preferably rectangular, directions with respect to each other.

A second oblong through-hole is provided in the second fixation plate section of the door mechanism. This second oblong through-hole extends in the vertical direction, i.e. orthogonal to both the first and second horizontal directions.

The first fixation plate section in the door panel may optionally comprise a third oblong through-hole extending in a second horizontal direction. Such third oblong through-hole extends for example through the sheet material of the door panel. The third oblong through-hole has an elongate shape with longer dimensions in the second horizontal direction than in a first horizontal direction perpendicular thereto.

In order to indirectly attach the door panel to the door mechanism via the intermediate interface member, the door panel is fixed to the interface member via a first fixation member vertically extending through the first oblong through-hole and optionally also extending through the third oblong through-hole. Furthermore, the interface member is fixed to the door mechanism via a second fixation member horizontally extending through the second oblong through-hole. The fixation members may have an elongate structure. Both fixation members each extend in a direction substantially orthogonal to the planes in which the respective oblong through-holes extend. For example, the fixation members may be screws. Such screws may have nuts at one or both opposing ends. By screwing the one or more nuts relative to the screw, such fixation member may be tightened or released. Alternatively, the fixation members may have other structures allowing tightening and releasing the fixation members. For example, the fixation members may be quick-release mechanisms.

Upon being tightened, such fixation member presses the components through which it extends against each other. Accordingly, due to friction between surfaces of the components being pressed against each other, these components may no more move in directions transverse to the extension direction of the respective fixation member. However, upon the fixation member no more pressing the components against each other such that the friction between the surfaces of the components is released, the components may move in directions transverse to the extension direction of the fixation member.

Accordingly, when the first fixation member is released, the door panel and the interface member being connected via this first fixation member extending through their respective through-holes may be moved relative to each other in horizontal directions. Particularly, due to the first fixation member extending through the first oblong through-hole in the interface member, the door panel and the interface member may be moved in the first horizontal direction with respect to each other. Furthermore, due to the first fixation member optionally extending through the third oblong through-hole in the door panel, the door panel and the interface member may be moved in the second horizontal direction with respect to each other. Accordingly, with an optional superposition of motions in these two horizontal directions, the door panel and the interface member may be moved in all horizontal directions. Accordingly, with the first fixation member being released, the position of the door panel may be adjusted in two orthogonal horizontal directions. Upon the first fixation member being tightened, the door panel may be fixed in such adjusted position.

Similarly, when the second fixation member is released, the interface member and the door mechanism being connected via the second fixation member extending through their respective through-holes may be moved relative to each other in the vertical direction. In other words, due to the second fixation member extending through the second oblong through-hole in the door mechanism, the interface member and the door mechanism may be moved in the vertical direction with respect to each other. Accordingly, with the second fixation member being released, the position of the interface member may be adjusted in the vertical direction. Upon the second fixation member being tightened, the interface member together with the door panel attached thereto may be fixed in such position.

Overall, with the intermediate interface member and the two or optionally even three oblong through-holes in the door panel, the interface member and the door mechanism forming the elevator door arrangement as described herein, the elevator door arrangement obtains an adjustability of the position of the door panel with respect to the door mechanism independently in at least two directions or even in all three dimensions. Accordingly, for example gaps between the door panel and neighboring elements within the elevator may be suitably adjusted in all spatial directions.

The elevator door arrangement comprises or could further comprise a specific lever mechanism. This lever mechanism comprises a first pivoting section being held relative to the door mechanism in the vertical direction and a second pivoting section being displaceably held relative to the door mechanism in the vertical direction via a so-called vertical distance adjustment member. Therein, the vertical distance adjustment member is configured for changing a vertical distance between the second pivoting section of the lever mechanism and an engagement position at the door mechanism. Furthermore, the lever mechanism pivotably engages with the second fixation member.

In other words, additional to the door panel, the door mechanism and the intermediate interface member, the elevator door arrangement may comprise a specific lever mechanism. Briefly summarized, this lever mechanism may be functionally interposed between the interface member and the door mechanism and may be configured such as to easily and precisely adjust a relative position between the interface member and the door mechanism in the vertical direction.

For such purpose, the lever mechanism comprises two pivoting sections. On the one hand, at least one of these pivoting sections may be displaceable such as to adjust its vertical position relative to the door mechanism. For such purpose, this displaceable pivoting section may comprise a vertical distance adjustment member with which the vertical distance between the second pivoting section and an engagement position located at the door mechanism may be easily and precisely adjusted. In other words, using the vertical distance adjustment member, the position of the second pivoting section with respect to the engagement position at the door mechanism may be varied in a vertical direction. On the other hand, the other pivoting section is held relative to the door mechanism and does not necessarily need to be displaceable relative to the door mechanism. In other words, the first pivoting section may be fixedly held at another engagement position at the door mechanism. Accordingly, upon changing the relative vertical position at the second pivoting section, the lever mechanism may be pivoted, i.e. reorientated.

Furthermore, the lever mechanism pivotably engages with the second fixation member connecting the interface member with the door mechanism. Preferably, the second fixation member extends through the second oblong through-hole in the door mechanism and then pivotably cooperates with the lever mechanism being pivotably held at the door mechanism. When the vertical position of the second pivoting section of the lever mechanism is changed using the vertical distance adjustment member, also the engagement position at which the second fixation member cooperates with the lever mechanism changes its vertical position and therefore the second fixation member is displaced relative to the door mechanism in the vertical direction. Accordingly, using the vertical distance adjustment member, the vertical position of the second fixation member may be indirectly adjusted.

Thus, as the second fixation member is connected to the interface member and indirectly to the door panel attached thereto, the vertical position of the door panel may be indirectly adjusted upon pivoting the lever mechanism using its vertical distance adjustment member. Such adjusting of the vertical position may be easy and precise.

Furthermore, due to a possible leveraged effect established by the lever mechanism, the vertical position of the door panel may for example be moved upwards only using the lever mechanism and its vertical distance adjustment member, i.e. without a technician necessarily manually lifting up the door panel.

In other words, in conventional approaches, a technician typically had to manually lift the door panel to an intended vertical position and then fix it to the door mechanism. Accordingly, the technician had to temporarily carry the entire weight of the door panel. This was strenuous work and hindered a precise adjustment of the door panel's vertical position. With the elevator door arrangement and its optional lever mechanism described herein, the technician may first attach the door panel via the interface member and the lever mechanism to the door mechanism. Upon being attached in such manner, the technician does no more need to carry the weight of the door panel. Then, the technician may adjust the vertical position of the door panel using the lever mechanism and its vertical distance adjustment member. Therein, the technician may have “both hands free” such that this adjustment of the vertical position of the door panel may be relatively easy and with high precision.

According to a specific embodiment, the vertical distance adjustment member is a screw which upon screwing changes the vertical distance between the second pivoting section of the lever mechanism and an engagement position at the door mechanism.

In other words, a screw may be used at the lever mechanism to adjust the vertical distance of its second pivoting section with respect to the engagement position at the door mechanism. For example, one end of such screw may engage with the second pivoting section of the lever mechanism and another end of the screw may engage with a portion of the door mechanism serving as a counter-bearing. Accordingly, upon screwing the screw, the relative position between the second pivoting section of the lever mechanism and the engagement position of the door mechanism may be displaced relative to each other, such displacement including a vertical displacement vector component resulting in vertically displacing the interface member and door panel attached to the lever mechanism.

According to an embodiment, the lever mechanism consists of a single integral lever piece and the vertical distance adjustment member.

In other words, the lever mechanism may be a simple arrangement comprising only two components, namely the integral lever piece and the vertical distance adjustment member. The integral lever piece may be a single component formed for example by punching and/or bending a metal sheet. At its first pivoting section, the integral lever piece may be adapted such as to fixedly engage with the door mechanism. For example, the first pivoting section may press against a rim provided at an edge of the door mechanism. At its second pivoting section, the lever piece may be configured for engaging with the vertical distance adjustment member. For example, the second pivoting section may comprise a through-hole with a thread through which a screw may be arranged such that the position of the screw with respect to the second pivoting section may be adjusted by turning the screw.

According to an embodiment, the first and second pivoting sections of the lever mechanism are arranged at opposing sides in relation to a position where the lever mechanism pivotably engages with the second fixation member.

Expressed in a different manner, the second fixation member interconnecting the interface member with the door mechanism may engage with the lever mechanism at a central position of the lever mechanism between a left-side pivoting section and a right-side pivoting section. Therein, when the first pivoting section is fixedly held with respect to the door mechanism and the second pivoting section is displaced with respect to the door mechanism using the vertical distance adjustment member, the second fixation member engaging with the integral lever piece in a central position thereof is also vertically displaced, thereby indirectly adjusting the vertical position of the door panel.

According to an embodiment, the interface member is an integral metal sheet element.

In other words, the interface member interconnecting the door panel and the door mechanism may be a simple single-piece element made from a metal sheet, e.g. from a steel sheet. For example, the metal sheet may be bent such as to obtain an L-shape in cross-section. Furthermore, through-holes such as the first oblong through-hole may be formed therein.

Such simple integral metal sheet element may be easily produced. Furthermore, when using a metal sheet with a sufficient thickness, such interface member may provide sufficient mechanical stiffness and rigidity for transmitting the loads generated by the door panel via the interface member to the door mechanism.

According to an embodiment, the first horizontal direction is parallel to an extension plane of the door panel.

In other words, the first horizontal direction in which the first oblong through-hole in the interface member extends is preferably parallel to the plane in which the door panel extends and in which the door panel shall be displaced upon opening and closing the elevator door arrangement. In such case, the second horizontal direction in which the optional third oblong through-hole in the door panel extends is preferably orthogonal to the extension plane of the door panel.

It is assumed that, with such implementation of the first and third oblong through-holes, both the door panel as well as the interface member may be easily fabricated with its oblong through-holes and/or both the door panel as well as the interface member may be provided with a sufficient structural stiffness and rigidity.

It shall be noted that various directions and planes as well as their orientations relative to each other are defined herein to include certain tolerances. For example, directions and planes defined to be rectangular or orthogonal, respectively, with respect to each other may be arranged at exactly 90° relative to each other or within a tolerance of for example 90°±10° or 90°±5°.

It shall be noted that possible features and advantages of embodiments of the invention are described herein mainly with respect to an elevator door arrangement, but also partly with respect to aspects of mounting such elevator door arrangement. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows a perspective overview of an elevator door arrangement;

FIGS. 2 through 4 show details of a conventional elevator door arrangement;

FIG. 5 shows a partial front view onto an elevator door arrangement according to an embodiment of the invention;

FIG. 6 shows a perspective view onto details of the elevator door arrangement according to an embodiment of the invention;

FIG. 7 shows a perspective view of an interface member for an elevator door arrangement according to an embodiment of the invention;

FIG. 8 shows a perspective view onto a first fixation plate section of a door panel for an elevator door arrangement according to an embodiment of the invention; and

FIGS. 9 and 10 show front views onto a lever mechanism in different configurations in an elevator door arrangement according to an embodiment of the present invention.

The figures are only schematic and not to scale. Same reference signs refer to same or similar features.

### DETAILED DESCRIPTION

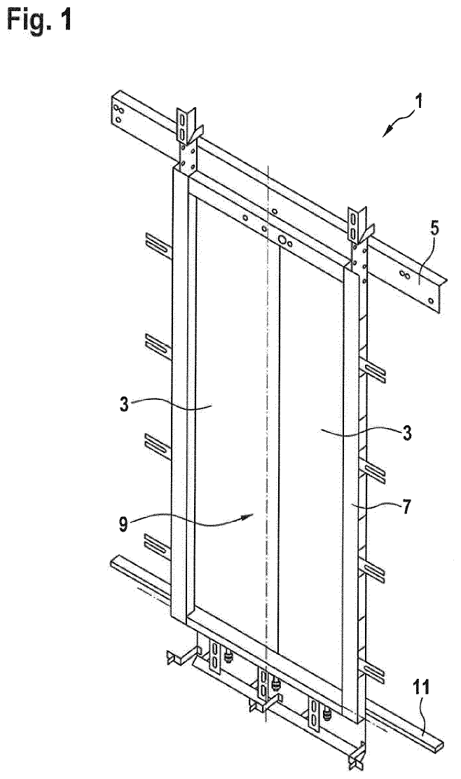

FIG. 1 shows a perspective overview of an elevator door arrangement 1 and shall be used for defining terms used hereinafter for identifying elements and features of the elevator door arrangement 1.

The elevator door arrangement 1 comprises two door panels 3 attached to a door mechanism 5. The door mechanism 5 is installed at a door frame 7 and is configured for displacing the door panels 3 in opposite horizontal directions such as to open or close a door opening 9 for providing or blocking, respectively, access to an elevator car (not shown). At a lower edge, the elevator door arrangement comprises a sill 11.

Generally, a position of the door panels 3 is to be adjusted in the elevator door arrangement 1 in order to establish suitable gaps between the door panels 3 and neighboring components or structures. On the one hand, these gaps should be sufficiently large for enabling, for example, a smooth and frictionless motion of the door panels 3 upon being opened or closed. On the other hand, these gaps should not be excessively large for limiting, for example, risks for passengers or for limiting mechanical tolerances between the door panels 3 and adjacent structures supporting them or guiding their motion.

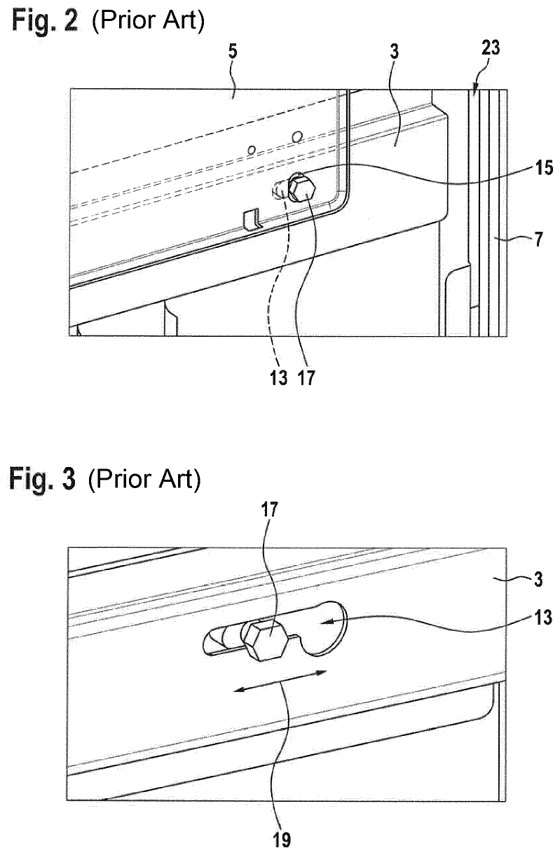

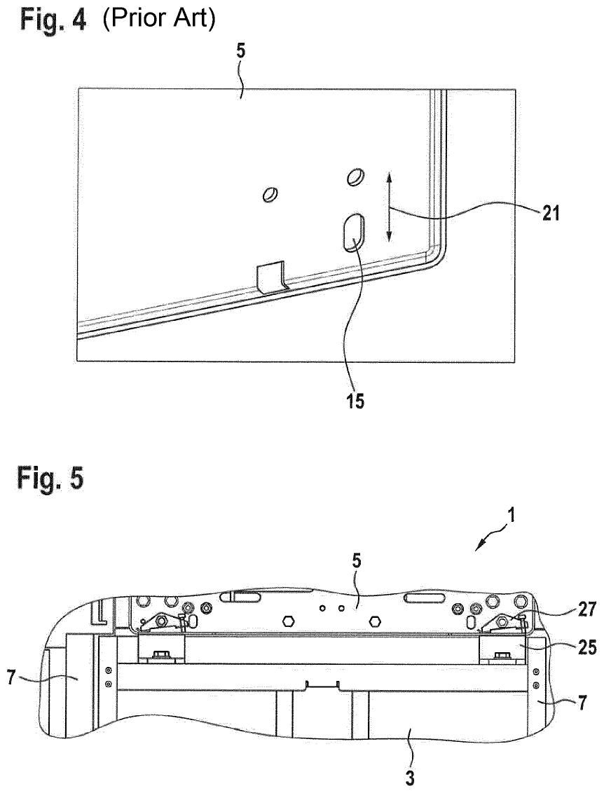

FIGS. 2 to 4 show details of a conventional elevator door arrangement in which door panels 3 are directly attached to the door mechanism 5. Therein a horizontal oblong through-hole 13 is provided close to an upper edge of the door panel 3 and a vertical oblong through-hole 15 is provided at a corresponding position at a lower edge of the door mechanism 5. The door panel 3 may then be attached to the door mechanism 5 using a screw 17 extending through both oblong through-holes 13, 15. As long as the screw 17 is not yet tightened, the door panel 3 and the door mechanism 5 may be displaced with respect to each other along the horizontal oblong through-hole 13 in a horizontal direction 19 as well as along the vertical oblong through-hole 15 in a vertical direction 21.

Accordingly, for example, a lateral gap 23 between lateral sides of the door panel 3 and neighboring columns of the frame 7 may be adjusted by suitably positioning the door panel 3 in the horizontal direction 19. Similarly, a vertical gap (not shown) between a top side of the door panel 3 and a neighboring header of the frame 7 may be adjusted by suitably positioning the door panel 3 in the vertical direction 21.

However, in such conventional configuration, it may be hard to adjust the vertical position of the door panel 3 without simultaneously also affecting its horizontal position and vice versa. Furthermore, no option exists for adapting a lateral gap for example between the door panel 3 and the sill 11 in another horizontal direction being transverse to the above-mentioned horizontal and vertical directions 19, 21. In other words, in the conventional approach, it was only possible to adjust the position of the door panel 3 in two dimensions and, without taking special care, such position adjusting was to a certain extent interdependent in both directions.

In order to overcome such deficiency, an elevator door arrangement 1 with 2-dimensional or even 3-dimensional door panel adjustability according to an embodiment of the present invention is proposed. In the following, an elevator door arrangement 1 with 3-dimensional door panel adjustability will be described.

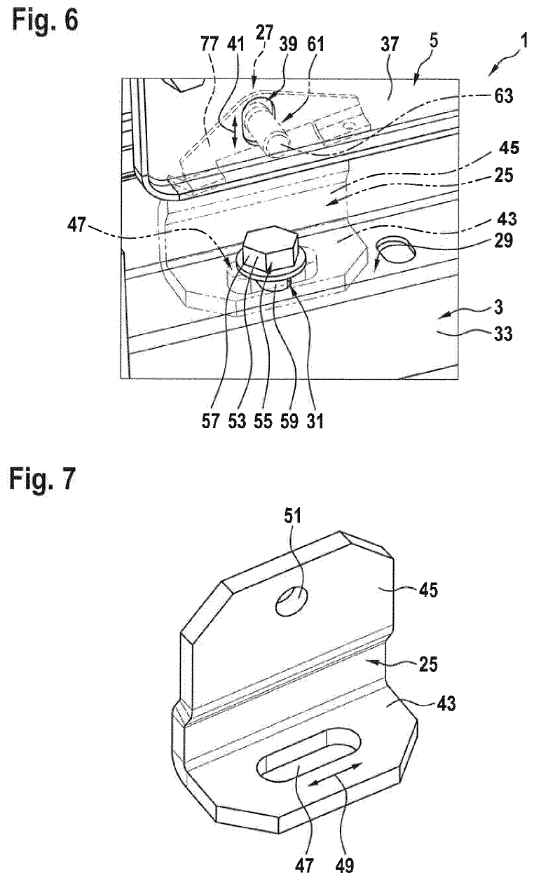

An overview showing substantial components and features of such elevator door arrangement 1 is shown in FIG. 5. A more detailed perspective partial view is shown in FIG. 6.

In the elevator door arrangement 1, a door panel 3 is not directly attached to a door mechanism 5 but via an intermediate interface member 25 and an optional lever mechanism 27.

Therein, the intermediate interface member 25 as well as the door panel 3 and the door mechanism 5 are structurally configured such as to enable cooperating in a way which allows displacing the door panel 3 in all spatial directions with respect to the door mechanism 5.

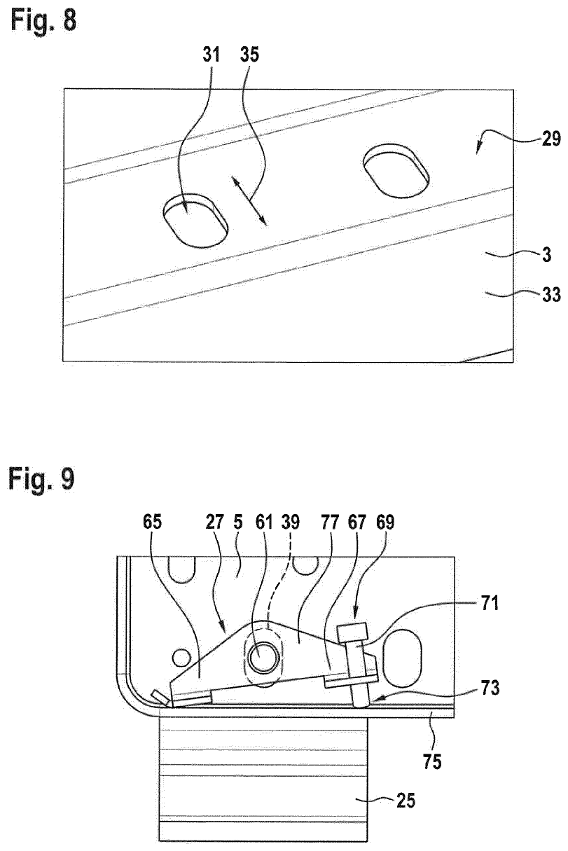

In order to establish such 3-dimensional door panel adjustability, various plate sections are provided at the door panel 3, the door mechanism 5 and the intermediate interface member 25. As shown in detail in FIG. 6 for the entire arrangement and in further detail in FIGS. 7 and 8 for the interface member 25 and the door panel 3, respectively, several oblong through-holes are provided in the different plate sections.

Specifically, the door panel 3 comprises a first fixation plate section 29 extending in a horizontal plane. The first fixation plate section 29 may be provided at or close to an upper edge of the door panel 3. For example, the door panel 3 may be made with a metal sheet. A major portion of this metal sheet forming a vertical plate section 33 extends in a vertical plane including the horizontal width dimension of the door panel 3. The first fixation plate section 29 may be formed by locally bending this metal sheet into the horizontal plane.

In the first fixation plate section 29, a third oblong through-hole 31 is provided. This third oblong through-hole 31 extends in a second horizontal direction 35 (see FIG. 8). Preferably, this second horizontal direction 35 is orthogonal to the horizontal width dimension of the door panel 3. For example, the third oblong through-hole 31 may have a length-to-width ratio of at least 2:1. For example, the length may be between 1 and 10 cm, preferably between 1 and 5 cm, and the width may be between 0.4 and 2 cm, preferably between 0.6 and 1.2 cm.

The door mechanism 5 comprises a second fixation plate section 37 extending in a vertical plane. For example, the door mechanism 5 may be made from a metal sheet, a major portion of which extends in the vertical plane including a width direction of the elevator door arrangement 1.

In the second fixation plate section 37, another oblong through-hole is provided, this through-hole being referred to herein as second oblong through-hole 39. This second oblong through-hole 39 extends in a vertical direction 41. A length-to-width ratio and/or dimensions of this second oblong through-hole 39 may be similar or same as those described for the third oblong through-hole 31.

The interface member 25 comprises a substantially L-shaped cross section (see particularly FIG. 7). For example, the interface member 25 may be made from a metal sheet bent into the L-shape. The interface member 25 comprises a first interconnection plate section 43 and a second interconnection plate section 45. The first interconnection plate section 43 extends parallel to the horizontal plane in which the first fixation plate section 29 of the door panel 3 extends. The second interconnection plate section 45 extends parallel to the vertical plane in which the second fixation plate section 37 of the door mechanism 5 extends.

A first oblong through-hole 47 is comprised in the first interconnection plate section 43. This first oblong through-hole 47 extends in a first horizontal direction 49 being perpendicular to the second horizontal direction 35. Preferably, this first horizontal direction 49 is parallel to an extension plane of the door panel 3. A length-to-width ratio and/or dimensions of this first oblong through-hole 47 may be similar or the same as those described for the third oblong through-hole 31. Close to an upper edge of the second interconnection plate section 45, a round through-hole 51 is provided.

On the one side, the interface member 25 is mechanically attached to the door panel 3 via a first fixation member 53 vertically extending through the first and third oblong through-holes 47, 31. This first fixation member 53 may be a screw 55. A head 57 of such screw 55 may abut to an upper surface of the first interconnection plate section 43 of the interface member 25. A shaft 59 of the screw 55 may extend through the first and third oblong through-holes 47, 31. A nut (not shown) at another end of such screw 55 may abut to a lower surface of the first fixation plate section 29 of the door panel 3. As long as the first fixation member 53 is not yet fixed or tightened, the door panel 3 may already be held at the interface member 25 in the vertical direction 41 but may still be displaced in both horizontal directions 35, 49, as the shaft 59 of the screw 55 may slide along the third oblong through-hole 31 and/or the first oblong through-hole 47. Upon tightening the first fixation member 53, the door panel 3 and the interface member 25 are held in a fixed position relative to each other.

On the other side, the interface member 25 is mechanically attached to the door mechanism 5 via a second fixation member 61 horizontally extending through the second through-hole 39 in the door mechanism 5. This second fixation member 61 may be a screw 63, a bolt or a similar elongate member. As long as the second fixation member 61 is not yet fixed or tightened, the interface member 25 with the door panel 3 attached thereto may be displaced vertically and a shaft of the second fixation member 61 may slide along the second oblong through-hole 39 in the door mechanism 5.

In principle, the second fixation member 61 could also be embodied with a screw 63, a head and a nut such that upon tightening the screw, the second interconnection plate section 45 of the interface member 25 is laterally pressed against the second fixation plate section 37 of the door mechanism 5, thereby fixing the interface member 25 and the door mechanism 5 in their relative position. However, in such configuration, the interface member 25 with the door panel 3 attached thereto would have to be manually positioned relative to the door mechanism 5 before then fixing the components relative to each other. Such approach might be difficult as a technician would have to simultaneously hold the weight of the door panel 3 and tighten the screw 63.

In order to overcome such difficulty, the lever mechanism 27 may be provided at a position functionally intermediate between the interface member 25 and the door mechanism 5.

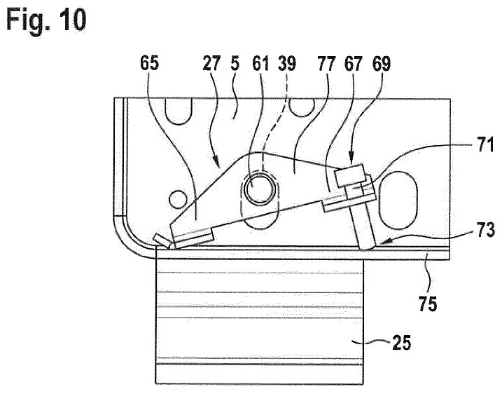

As also shown in FIGS. 9 and 10, such lever mechanism 27 comprises an integral lever piece 77 with a first pivoting section 65 being held relative to the door mechanism 5 in the vertical direction 41 and a second pivoting section 67 being displaceably held relative to the door mechanism 5 in the vertical direction 41 via a vertical distance adjustment member 69.

Therein, the vertical distance adjustment member 69 is configured for changing a vertical distance between the second pivoting section 67 of the lever mechanism 27 and an engagement position 73 at the door mechanism 5. Furthermore, the lever mechanism 27 engages with the second fixation member 61 in a pivoting manner.

In the embodiment shown, the vertical distance adjustment member 69 is a screw 71. This screw 71 may engage with a threading provided in the second pivoting section 67 of the lever mechanism 27. Accordingly, upon screwing this screw 71, the lever mechanism 27 may be brought into different configurations as shown in FIGS. 9 and 10, respectively. Particularly, the vertical distance between the second pivoting section 67 of the lever mechanism 27 and the engagement position 73 at a rim 75 formed at an edge of the door mechanism 5 may be adjusted upon tightening or releasing the screw 71.

Thus, as the second fixation member 61, on the one hand, engages with the lever mechanism 27 and, on the other hand, is held in the through-hole 51 in the interface member 25, the vertical position of the door panel 3 attached to the interface member 25 may be adjusted by simply screwing the screw 71 in the correct direction. Accordingly, adjusting the vertical position of the door panel 3 is significantly simplified.

Summarized in a slightly differing wording, the elevator door arrangement described herein may allow a door panel adjustment in three orthogonal directions. The door panel adjustability may be such that a first gap between the door panel and a sill may be adjusted, a second gap between the door panel and a header may be adjusted and a third gap between the door panel and columns are adjusted. The three gaps may be in three directions orthogonal to each other. Thereby, the proposed elevator door arrangement may allow more flexibility during door installation. Furthermore, it may allow a precise adjustment in a vertical direction. Additionally, a vertical distance may be kept in case of a door panel being removed. The elevator door arrangement may be applied to automatic doors with central or lateral opening. Embodiments of the elevator door arrangement may provide for advantages such as:
allow the correction of door panel due to problem in built construction related to align and dimensions;
allow a quick and precise adjustment of distance between sill and door panel;
allow the adjustment of parallelism between the door panel and a column;
keep the position of independent sides even if the door is removed;
cheap solution;
easy to implement solution.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-7. (canceled)

8. An elevator door arrangement with at least 2-dimensional door panel adjustability, the elevator door arrangement comprising:
a door panel;
an interface member;
a door mechanism supported by a door frame fixedly installed within the elevator door arrangement, the door mechanism being displaceable relative to the door frame, wherein the door panel is fixedly connected to the door mechanism by the interface member;
wherein the door panel includes a first fixation plate section extending in a horizontal plane;
where the door mechanism includes a second fixation plate section extending in a vertical plane;
wherein the interface member includes a first interconnection plate section and a second interconnection plate section, the first interconnection plate section extending parallel to the horizontal plane and the second interconnection plate section extending parallel to the vertical plane;
wherein the first interconnection plate section has a first oblong through-hole extending in a first horizontal direction parallel to the horizontal plane;
wherein the second fixation plate section has a second oblong through-hole extending in a vertical direction in the vertical plane; and
wherein the door panel is fixed to the interface member by a first fixation member vertically extending through the first oblong through-hole and the interface member is fixed to the door mechanism by a second fixation member horizontally extending through the second oblong through-hole, wherein the first horizontal direction is parallel to an extension plane of the door panel, and whereby the door panel is adjustable in two dimensions relative to the door mechanism when the first and second fixation members are released.

9. The elevator door arrangement according to claim 8 wherein the first fixation plate section has a third oblong through-hole extending in a second horizontal direction being transverse to the first horizontal direction, and wherein the door panel is fixed to the interface member via the first fixation member vertically extending through the first and third oblong through-holes, thereby establishing a 3-dimensional door panel adjustability for the elevator door arrangement when the first and second fixation members are released.

10. The elevator door arrangement according to claim 8 including a lever mechanism having a first pivoting section being held relative to the door mechanism in the vertical direction and a second pivoting section being displaceably held relative to the door mechanism in the vertical direction by a vertical distance adjustment member, the vertical distance adjustment member being configured for changing a vertical distance between the second pivoting section of the lever mechanism and an engagement position at the door mechanism, and wherein the lever mechanism pivotably engages with the second fixation member.

11. The elevator door arrangement according to claim 10 wherein the vertical distance adjustment member is a screw that, when rotated, changes a vertical distance between the second pivoting section of the lever mechanism and the engagement position at the door mechanism.

12. The elevator door arrangement according to claim 10 wherein the lever mechanism includes a single integral lever piece and the vertical distance adjustment member.

13. The elevator door arrangement according to claim 10 wherein the first and second pivoting sections are arranged at opposing sides in relation to a position where the lever mechanism pivotably engages with the second fixation member.

14. The elevator door arrangement according to claim 8 wherein the interface member is an integral metal sheet element.
